(19) United States
(12) Patent Application Publication
(10) Pub. No.: US 2023/0053863 A1
(43) Pub. Date: Feb. 23, 2023

(54) FRAME-TYPE HEATING ASSEMBLY, HEATING UNIT, AND ATOMIZATION SYSTEM

(71) Applicant: Shenzhen Huachengda Precision Industry Co. Ltd., Shenzhen, Guangdong (CN)

(72) Inventor: Ping Chen, Shenzhen, Guangdong (CN)

(21) Appl. No.: 17/800,223

(22) PCT Filed: Jun. 23, 2020
(86) PCT No.: PCT/CN2020/097710

§ 371 Date: Aug. 16, 2022

(51) Int. Cl. A24F 40/46; A24F 40/44; A24F 40/485; A24F 40/10; H05B 6/10

(52) U.S. Cl. CPC A24F 40/46; A24F 40/44; A24F 40/485; A24F 40/10; H05B 6/108

(57) ABSTRACT

The invention provides a frame-type heating assembly, including a heating sheet and a reinforcing frame. The heating sheet includes a heating portion and a connecting portion that is connected to the heating portion and configured for electrical connection with an external circuit. The heating sheet and the reinforcing frame are arranged side by side to improve the strength of the heating sheet. The invention further provides a heating unit including the heating assembly, a liquid conducting member configured for conducting liquid to the heating assembly, and a cover. The invention further provides an atomization system including a housing and the heating assembly disposed in the housing. The side of the heating assembly where the heating sheet is located faces an inner wall of the housing. The reinforcing frame body plays a role in supporting the heating sheet, so that the strength of the heating sheet is improved.

### FIELD

The present invention relates to the technical field of heating, and more specifically, to a frame-type heating assembly, a heating unit, and an atomization system.

### BACKGROUND

A heating sheet may be applied to an atomizer to heat and atomize the liquid in the atomizer. Currently, there are several problems in the existing heating sheet:

1, Due to the requirements of the circuit and the heating area, the heating sheet needs to be hollowed out to form a circuitous heating circuit, resulting in a relatively small link contact of the sheet-like heating element.

2, In order to have a larger heating area, the heating circuit needs to be circuitous, resulting in frame portions uneven and unsupported. The strength of the product is weak, a deformation is easily caused during transportation and assembly, and mass production is not facilitated.

3, The support strength of the heating sheet is not enough, and the attaching degree between the heating sheet and a liquid conducting cotton is difficult to be ensured. If the contact is poor, a dry burning may be occurred easily at a local position to produce harmful substances and bad user experience. The size and shape of the product are not facilitated to be standardized in the design, which is not conducive to the production.

4, The thickness of the heating sheet is limited by the strength and cannot be thinned, resulting in the problems of a large conductor cross-sectional area and a slow heat startup when powered on.

### SUMMARY

A technical problem to be solved by the present invention is, aiming to the above defect in the prior art, to provide an improved heating assembly, an improved heating unit, and an improved atomization system.

A technical solution adopted by the present invention to solve the technical problem is to provide a heating assembly, including:

a heating sheet, including a heating portion and a connecting portion that is connected to the heating portion and configured for electrical connection with an external circuit; and

a reinforcing frame; wherein the heating sheet and the reinforcing frame are arranged side by side to improve the strength of the heating sheet.

Preferably, the heating sheet is combined with a surface of the reinforcing frame, or at least part of the heating sheet is embedded in the reinforcing frame.

Preferably, the heating sheet is embedded on the surface of the reinforcing frame.

Preferably, the heating sheet is entirely embedded in the reinforcing frame.

Preferably, the heating sheet is attached to the surface of the reinforcing frame.

Preferably, the heating assembly includes an electrode, and the electrode is electrically connected with the connecting portion of the heating sheet to energize the heating sheet through the electrode.

Preferably, the electrode is a contact electrode, and is electrically connected to the heating sheet by contacting the connecting portion of the heating sheet.

Preferably, the electrode is an electrode lead, which is connected to the connecting portion of the heating sheet and led out from a surface of the connecting portion.

Preferably, the electrode lead extends through the connecting portion of the heating sheet to be connected to the connecting portion.

Preferably, the reinforcing frame is made of an insulating material.

Preferably, the heat resistance temperature of the reinforcing frame is above 200° C.

Preferably, the reinforcing frame is at least combined with all or part of the edge of the heating portion of the heating sheet.

Preferably, the reinforcing frame includes an outer frame portion and an inner frame portion, the inner frame portion is arranged in a frame of the outer frame portion, and the outer frame portion is combined with the edge of the heating portion of the heating sheet.

Preferably, the outer frame portion and the inner frame portion are combined to form a hollow structure.

The present invention further provides a heating unit, including:

the above heating assembly;

a liquid conducting member configured for conducting liquid to the heating assembly; and

a cover; wherein the cover, the liquid conducting member and the heating assembly are combined, and the liquid conducting member is disposed between the cover and the heating assembly.

Preferably, the cover is provided with a liquid inlet hole communicated with the liquid conducting member for liquid to enter the liquid conducting member.

Preferably, the bottom of the cover is connected with the liquid conducting member, the top of the cover is provided with a first air port, and a lateral side of the cover is provided with a second air port communicated with the first air port, for airflow to pass therethrough.

Preferably, the reinforcing frame includes an outer frame portion and an inner frame portion, the inner frame portion is arranged in a frame of the outer frame portion, the inner frame portion of the reinforcing frame is provided with a first clearance space, the heating portion of the heating sheet is provided with a second clearance space, and the cover is provided with a first through hole, and the first clearance space, the second clearance space and the first through hole are communicated to allow airflow to pass therethrough.

The present invention further provides an atomization system, including a housing, and further including the heating assembly of the above; wherein the heating assembly is disposed in the housing, and the side of the heating assembly where the heating sheet is located faces an inner wall of the housing, and the heating assembly is spaced apart from the inner wall of the housing and parallel or inclined with respect to the inner wall of the housing, to allow airflow to pass between the heating sheet and the inner wall of the housing.

Preferably, the heating assembly includes two heating assemblies arranged on two sides of the inner wall of the housing, to allow airflow to pass between the heating sheet and the inner wall of the housing.

The implementation of the present invention provides at least the following beneficial effects: the reinforcing frame plays the role of supporting the heating sheet, so as to improve the strength of the heating sheet.

### BRIEF DESCRIPTION OF THE DRAWINGS

Subject matter of the present invention will be described in even greater detail below based on the exemplary figures. In the accompanying drawings:

FIG. 1 is a perspective view of a heating assembly in an embodiment of the present invention;

FIG. 2 is a perspective view of a heating sheet of the heating assembly of FIG. 1;

FIG. 3 is a perspective view of a reinforcing frame of the heating assembly of FIG. 1 (FIG. 3-1 and FIG. 3-2 illustrates two embodiments respectively);

FIG. 4 is a schematic diagram of a combination mode of the heating sheet and the reinforcing frame in a first embodiment of the present invention;

FIG. 5 is a schematic diagram of a combination mode of the heating sheet and the reinforcing frame in a second embodiment of the present invention;

FIG. 6 is a schematic diagram of a combination mode of the heating sheet and the reinforcing frame in a third embodiment of the present invention;

FIG. 7 is a schematic diagram of the structure of the heating sheet and an electrode in a first embodiment of the present invention;

FIG. 8 is a schematic diagram of the structure of the heating sheet and the electrode in a second embodiment of the present invention;

FIG. 9 is a schematic diagram of the structure of the heating sheet and the electrode in a third embodiment of the present invention;

FIG. 10 is a schematic diagram of the structure of the heating sheet and the electrode in a fourth embodiment of the present invention;

FIG. 11 is a schematic diagram of the structure of the heating sheet and the electrode in a fifth embodiment of the present invention;

FIG. 12 is a schematic diagram of the structure of the heating sheet and the electrode in a sixth embodiment of the present invention;

FIG. 13 is a perspective view of a heating unit in a first embodiment of the present invention;

FIG. 14 is an exploded view of the heating unit in FIG. 13;

FIG. 15 is an exploded view of the heating unit in FIG. 13;

FIG. 16 is a sectional view of the heating unit in FIG. 13 (wherein the sectioning position is C1-C1 in FIG. 13);

FIG. 17 is a partial enlarged view of part A in FIG. 16;

FIG. 18 is a schematic diagram of the heating unit in FIG. 13 in contact with liquid and of the flow direction of airflow (wherein the arrows indicate the flow direction of the airflow, and wherein the sectioning position is C1-C1 in FIG. 13);

FIG. 19 is a schematic diagram of the structure of the heating unit and the inner wall of a housing of an atomizer in a first embodiment of the present invention;

FIG. 20 is a schematic diagram of the structure of the heating unit and the inner wall of the housing of the atomizer in a second embodiment of the present invention;

FIG. 21 is a schematic diagram of the structure of the heating unit and the inner wall of the housing of the atomizer in a third embodiment of the present invention;

FIG. 22 is a schematic diagram of the structure of the heating unit and the inner wall of the housing of the atomizer in a fourth embodiment of the present invention;

FIG. 23 is a perspective view of a heating unit in a second embodiment of the present invention;

FIG. 24 is another perspective view of the heating unit in FIG. 23;

FIG. 25 is a sectional view of the heating unit in FIG. 23 (wherein the sectioning position is C2-C2 in FIG. 23);

FIG. 26 is another sectional view of the heating unit in FIG. 23 (wherein the section is perpendicular to the section in FIG. 25, and wherein the section position is C3-C3 in FIG. 23);

FIG. 27 is a sectional view of the heating unit in FIG. 23 in contact with liquid when in use (wherein the sectioning position is C2-C2 in FIG. 23);

FIG. 28 is a sectional view of the heating unit in FIG. 23 in contact with liquid and of the flow direction of airflow (wherein the section is perpendicular to the section in FIG. 27, and the arrows indicate the flow direction of the airflow, and wherein the section position is C3-C3 in FIG. 23);

FIG. 29 is a perspective view of a heating unit in a third embodiment of the present invention;

FIG. 30 is another perspective view of the heating unit in FIG. 29;

FIG. 31 is a sectional view of the heating unit in FIG. 29 (wherein the arrows indicate the flow direction of airflow, and wherein the sectioning position is C4-C4 in FIG. 29);

FIG. 32 is a perspective view of a heating sheet of the heating unit in FIG. 29;

FIG. 33 is a perspective view of a reinforcing frame of the heating unit in FIG. 29;

FIG. 34 is an exploded view of an atomizer in an embodiment of the present invention;

FIG. 35 is a top view of the atomization device in FIG. 34;

FIG. 36 is a sectional view of the atomizer in FIG. 34 (wherein the sectioning position is A-A in FIG. 35); and

FIG. 37 is another sectional view of the atomizer in FIG. 34 (wherein the sectioning position is B-B in FIG. 35).

Wherein, the reference marks in the drawings indicate: heating sheet 1, heating portion 11, connecting portion 12, reinforcing frame 2, outer frame portion 21, inner frame portion 22, hollow structure 2a, electrode 3, contact electrode 31, electrode lead 32, liquid conducting member 4, cover 5, liquid inlet hole 52, first air port 53a, second air port 53b, housing 6, liquid storage cavity 61, liquid storage cavity sealing member 7, base 8, first clearance space 9a, second clearance space 9b, first through hole 9c, second through hole 9d, liquid 100.

### DETAILED DESCRIPTION

For better understanding of the technical features, objects and effects of the present invention, the specific embodiments of the present invention will be described in detail with reference to the accompanying drawings. It should be understood that the orientation or the position relationship indicated by relative terms such as “front”, “back”, “upper”, “lower”, “left”, “right”, “longitudinal”, “lateral”, “vertical”, “horizontal”, “top”, “bottom”, “inner”, “outer”, “head”, and “tail” should be construed to refer to the orientation or the position relationship as then described or as illustrated in the drawings under discussion. These relative terms are for convenience of description and do not require that the present invention be constructed or operated in a particular orientation.

It should be further noted that, in the present invention, unless specified or limited otherwise, the terms “mounted”, “connected”, “coupled”, “fixed”, “arranged”, “disposed” and the like are used broadly, and can be, for example, fixed connections, detachable connections, or integral connections; can be mechanical connection or electrical connection; can be direct connections, or indirect connections via intervening structures; can be inner communications of two components, or interaction relationships between two components. When one component is described to be located on” or “located below” another component, it means that the component can be “directly” or “indirectly” located on another component, or there may be one or more intervening component located therebetween. The terms “first”, “second”, “third” and the like are only used for the convenience of describing the technical solution, and cannot be understood as indicating or implying the relative importance or implicitly indicating the number of the indicated technical features. Therefore, features defined with “first”, “second”, “third”, etc. may explicitly or implicitly indicates that one or more of these features can be included. For those of ordinary skill in the art, the specific meaning of the above-mentioned terms in the present invention can be understood according to specific circumstances.

In the description hereinbelow, for purposes of explanation rather than limitation, specific details such as specific systematic architectures and techniques are set forth in order to provide a thorough understanding of the embodiments of the present invention. However, it will be apparent to persons skilled in the art that the present invention may also be implemented in absence of such specific details in other embodiments. In other instances, detailed descriptions of well-known systems, devices, circuits, and methods are omitted so as not to obscure the description of the present invention with unnecessary detail.

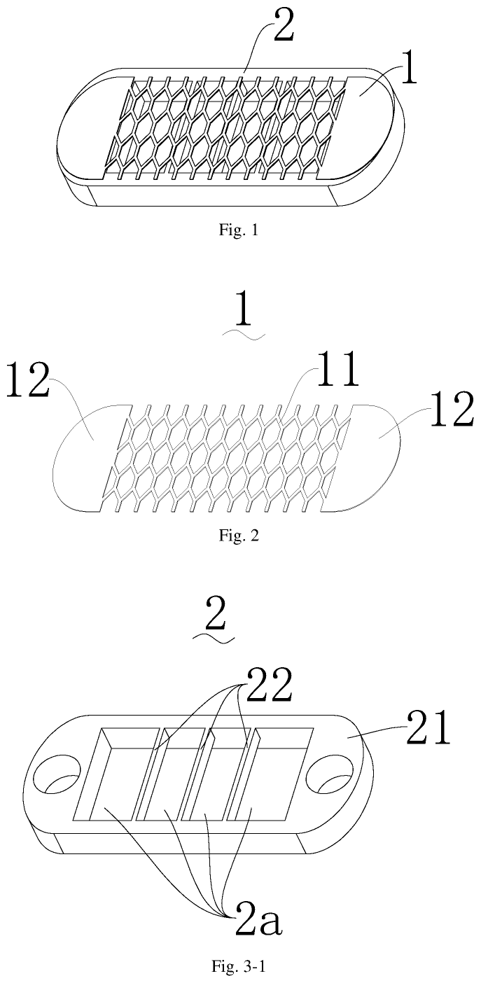

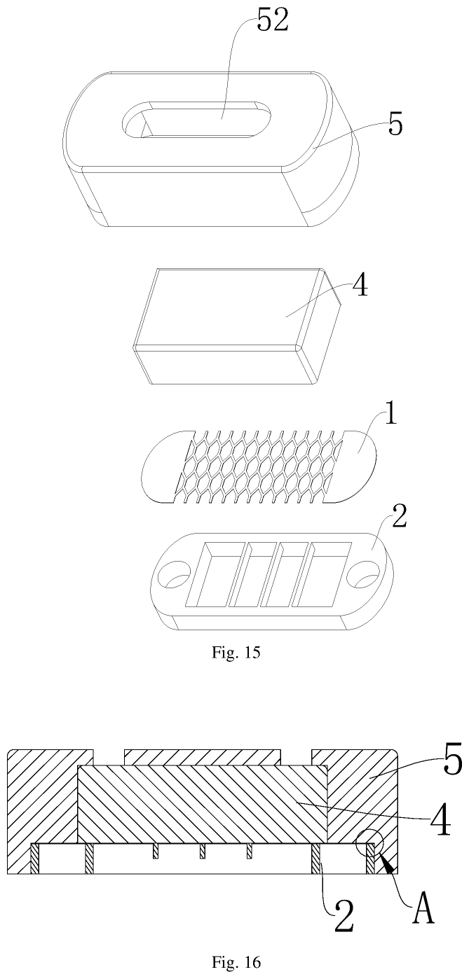

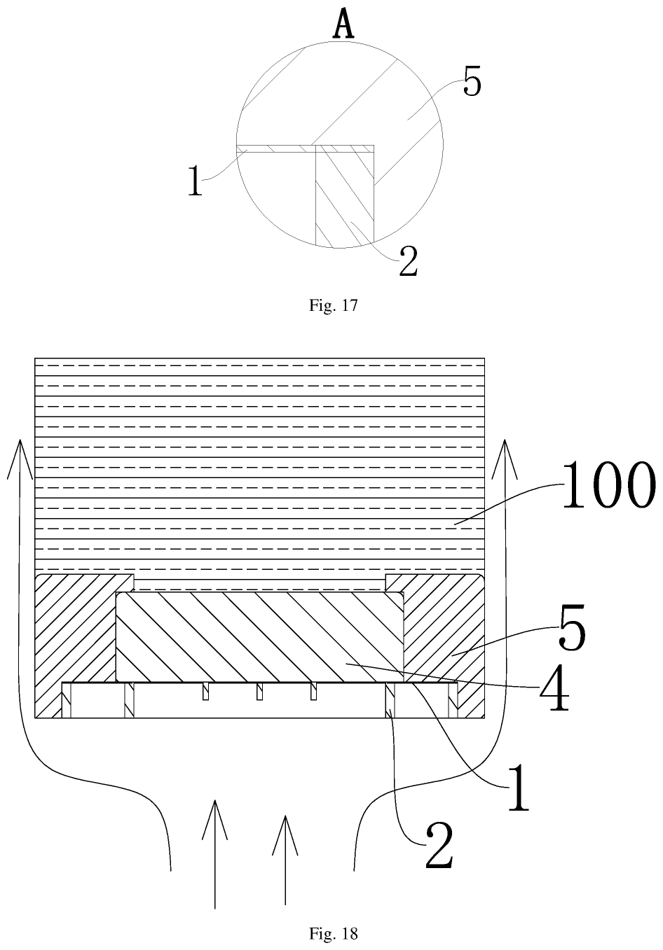

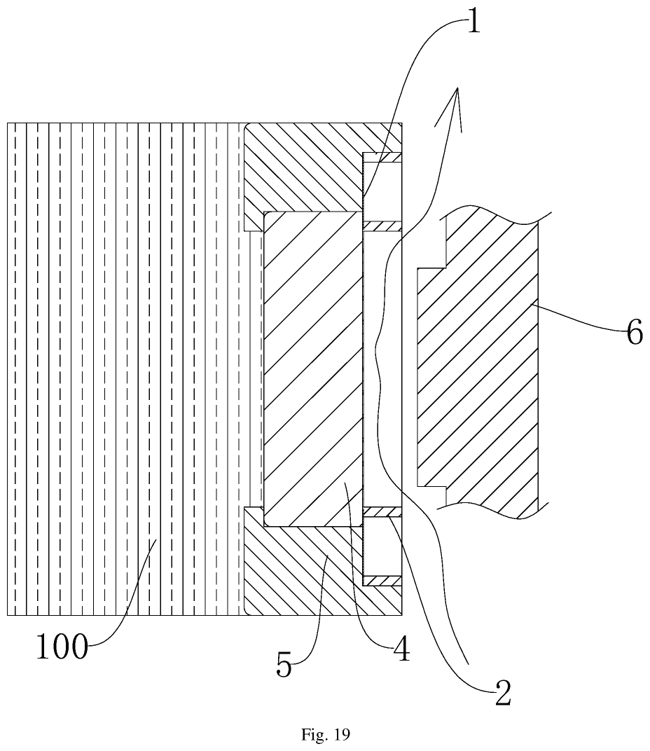

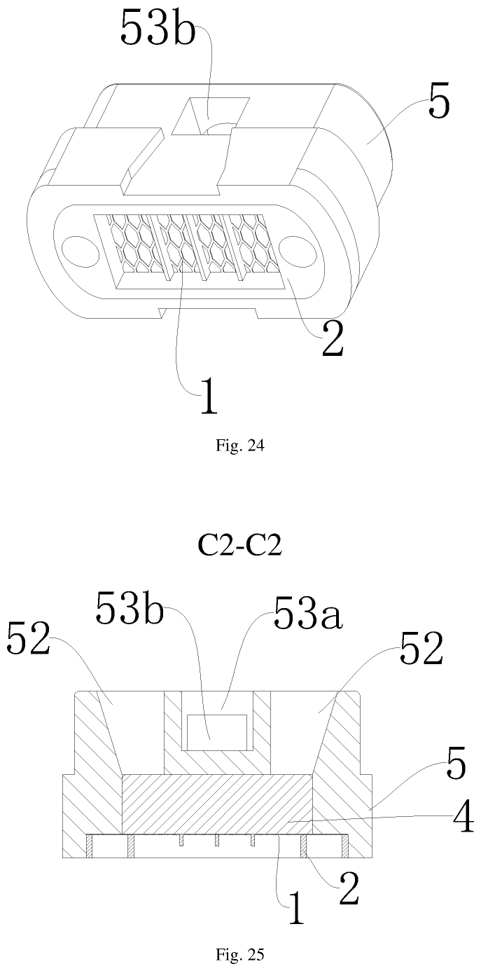

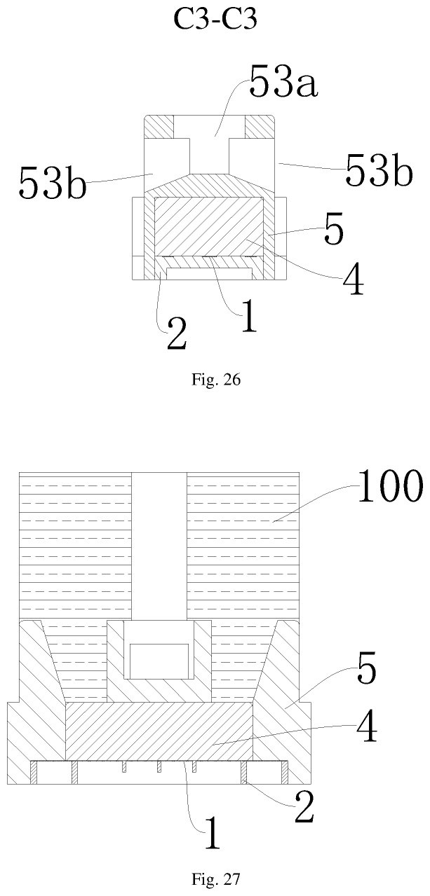

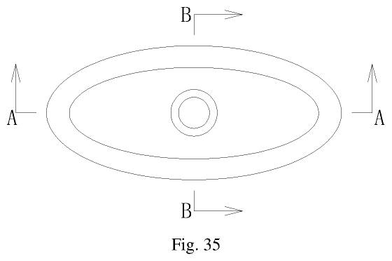

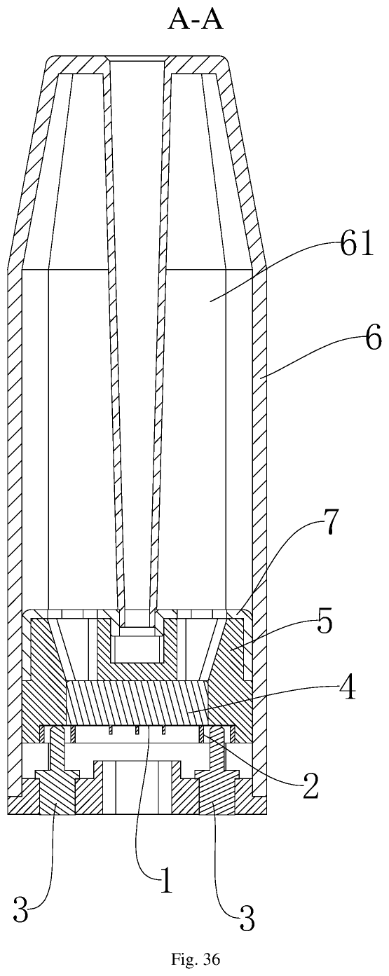

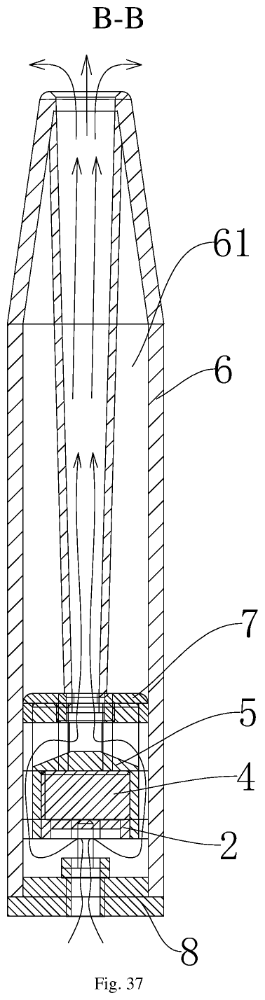

Referring to FIGS. 1-37, a frame-type heating assembly in some embodiments of the present invention includes:

a heating sheet 1, including a heating portion 11, and a connecting portion 12 that is connected with the heating portion 11 and configured for electrical connection with an external circuit; and

a reinforcing frame 2, wherein the heating sheet 1 and the reinforcing frame 2 are arranged side by side to improve the strength of the heating sheet 1.

The reinforcing frame 2 plays a role of supporting the heating sheet 1, thereby improving the strength of the heating sheet 1.

The heating assembly has the following beneficial effects:

1. The strength of the heating sheet 1 is improved, and the attaching degree with a liquid conducting member 4 may be better without the problem of dry burning.

2. The heating assembly is good in strength, good in consistency during transportation and assembly, and facilitated to realize mass automatic production.

3. The implementation of modularization is facilitated, and the design and application of the product are facilitated.

4. The heating sheet 1 is not affected by the thickness factor, thus may be made very thin, and the section of the connecting portion 12 of the heating sheet 1 can be made smaller, thereby achieving a faster heat startup, a smaller power, and a better smoke experience.

The reinforcing frame 2 is made of a high-temperature resistant inorganic non-metallic material or a high-temperature resistant insulating material, such as a high-temperature resistant plastic material.

The heat-resistant temperature of the reinforcing frame 2 is above 200° C.

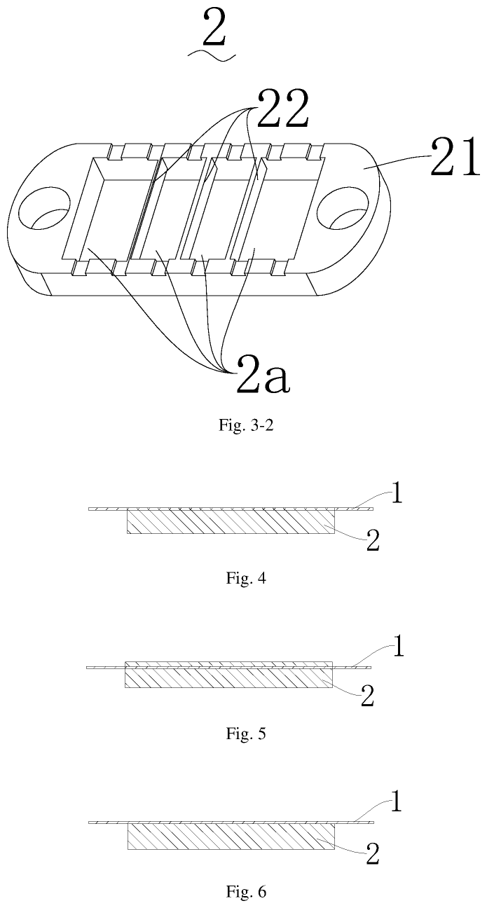

The reinforcing frame 2 is at least combined with all or part of the edge of the heating portion 11 of the heating sheet 1. Referring to FIG. 3-1, if the edge of the reinforcing frame 2 is a flat plane, the reinforcing frame 2 may be combined with all of the edge of the heating portion 11 of the heating sheet 1. Referring to FIG. 3-2, if the edge of the reinforcing frame 2 is not a flat plane, the reinforcing frame 2 may be combined with part of the edge of the heating portion 11 of the heating sheet 1.

The reinforcing frame 2 is in the shape of a frame, a ring or a runway.

The reinforcing frame 2 includes an outer frame portion 21 and an inner frame portion 22. The inner frame portion 22 is disposed in the frame of the outer frame portion 21, the outer frame portion 21 is disposed at the periphery of the inner frame portion 22 and surrounds the inner frame portion 22. The outer frame portion 21 is combined with the edge of the heating portion 11 of the heating sheet 1, and the inner frame portion 22 is combined with the middle portion of the heating sheet 1.

The outer frame portion 21 and the inner frame portion 22 are combined to form a hollow structure 2a, and the inner frame portion 22 includes a transverse frame disposed transversely and/or a longitudinal frame disposed longitudinally. The thicknesses of the outer frame portion 21 and the inner frame portion 22 may be the same, or one may be thicker than the other. In the embodiments of FIGS. 1 to 3, the inner frame portion 22 is in a grid shape, and the outer frame portion 21 is thicker than the inner frame portion 22; and the outer frame portion 21 is in a rectangular frame shape.

The heating portion 11 of the heating sheet 1 is curved or reticulated, and the connecting portion 12 is disposed at the edge of the heating portion 11. Typically, two connecting portions 12 are provided, which are disposed on the two sides of the heating portion 11 respectively. The connecting portion 12 is configured to be connected with the external circuit as an electrode 3, so that the heating portion 11 is heated when electrified.

The heating sheet 1 is made of a plane metal sheet by cutting, etching, stamping or the like, and the plane metal sheet is hollowed out to form the heating circuit. The hollowed out heating sheet 1 includes a plurality of conductive heating trace lines, electrodes 3 at the two ends of the lines, and a connecting rib.

The material of the metal sheet generally includes: stainless steel series, iron chromium aluminum alloy series, pure nickel, nickel chromium alloy, nickel iron alloy, copper nickel alloy or other nickel based alloy series, metal titanium, or titanium alloy series.

The reinforcing frame 2 is generally made of a high-temperature resistant insulating material through injection molding, grouting, crimping, welding, punching, bonding or the like. The above-mentioned heating sheet 1 is combined with the reinforcing frame 2.

The material of the reinforcing frame 2 generally includes: an inorganic non-metallic material with a high-temperature resistance such as ceramic, glass, quartz or mica, or a high-temperature resistant insulating material such as PEEK, nylon, LCP or PPSU. The temperature resistance of the insulating support material is more than 200 degrees Celsius.

Currently, the thickness of the material of the heating sheet 1 used in the industry is generally more than 0.1, and if the thickness is less than 0.1, the heating sheet 1 will have no enough support after being curled into a cylinder, and thus have a poor fitting with the cotton, which will easily cause a dry burning. This invention can realize the application of the heating sheet 1 in the thickness range of 0.01-0.6. The current heating sheet 1 needs to be curled into a cylinder, generally with a shape of rectangular. By the design of the heating assembly of the invention, some other special shapes of the heating sheet 1 may be realized.

As for the combination mode of the heating sheet 1 and the reinforcing frame 2, the heating sheet 1 may be combined with a surface of the reinforcing frame 2, or at least part of the heating sheet 1 may be embedded in the reinforcing frame 2.

Referring to FIG. 4, in some embodiments, the heating sheet 1 is embedded on a surface of the reinforcing frame 2. The advantage of this arrangement is that there is no barrier between the liquid conducting member 4 attached to the heating sheet 1 and the heating sheet 1, thus the fitting degree is better, and the heating sheet 1 can also be well fixed by the reinforcing frame 2.

Referring to FIG. 5, in some embodiments, the heating sheet 1 is embedded in the reinforcing frame 2. The advantage of this arrangement is that the heating sheet 1 is completely embedded in the reinforcing frame 2 and thus is firmer, so that a thinner heating sheet 1 may be selected. When the liquid conducting member 4 is attached, the heating sheet 1 can be pressed by pressure.

Referring to FIG. 6, in some embodiments, the heating sheet 1 is attached to a surface of the reinforcing frame 2. This is because the insulating reinforcing frame 2 cannot be integrally formed with the heating sheet 1 due to some molding methods of the insulating reinforcing frame 2, and thus the heating sheet 1 may be attached to the surface of the insulating support. The advantage is that the reinforcing frame 2 may be made of a material with a higher temperature resistance.

The heating assembly includes electrodes 3, which are connected with the connecting portion 12 of the heating sheet 1 to energize the heating sheet 1 through the electrodes 3.

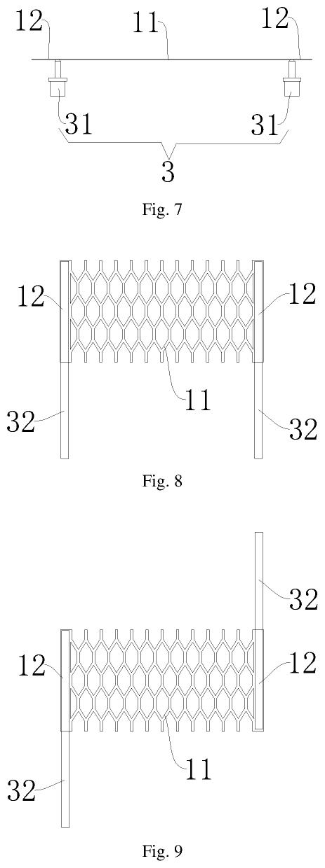

Referring to FIG. 7, in some embodiments, the electrode 3 is a contact electrode 31, which is electrically connected with the heating sheet 1 by contacting a surface of the connecting portion 12 of the heating sheet 1.

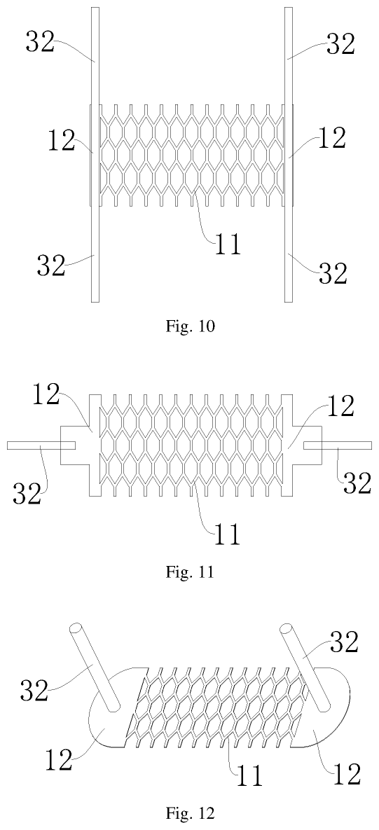

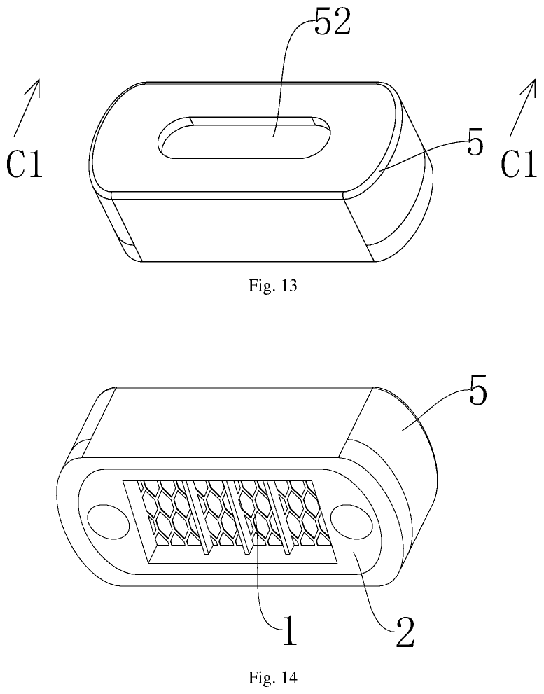

In other embodiments, the electrode 3 is an electrode lead 32, which is connected to the connecting portion 12 of the heating sheet 1 and led out from a surface of the connecting portion 12. The electrode lead 32 may be connected to the connecting portion 12 of the heating sheet 1 by welding. FIG. 8 shows the way that the electrode leads 32 are led out toward a same side, FIGS. 9 to 10 show the way that the electrode leads 32 are led out toward two sides, and FIG. 11 shows the way that the electrode leads 32 are led out toward the lateral sides. Further, referring to FIG. 12, the electrode leads 32 may alternatively extend through the connecting portion 12 of the heating sheet 1 and be led out, to be connected and conducted with the connecting portion 12.

Referring to FIGS. 13 to 18, a heating unit in some embodiments of the present invention includes:

the above heating assembly;

a liquid conducting member 4 configured to conduct liquid to the heating sheet 1 of the heating assembly, wherein the liquid conducting member 4 may be a ceramics or a liquid conducting cotton; and

a cover 5, wherein the cover 5, the liquid conducting member 4 and the heating assembly are assembled, the liquid conducting member 4 is arranged between the cover 5 and the heating assembly, the cover 5 is matched with the liquid conducting member 4, the cover 5 is covered on the liquid conducting member 4, the heating assembly is matched with the liquid conducting member 4, and one side of the heating assembly is attached to the liquid conducting member 4.

The cover 5 may not be provided with a snap structure, and the upper cover and the insulating support are connected by bonding, ultrasonic fusion or the like. Referring to FIGS. 13 to 18, in some embodiments, the cover 5 is provided with a liquid inlet hole 52 configured for liquid to enter and communicated with the liquid conducting member 4, so that the liquid can reach the liquid conducting member 4. The cover 5 with this structure is generally applied to the heating assembly with a horizontal placement, a bottom air inlet mode, and a lateral side air outlet, where the flow direction of the airflow is shown in FIG. 18.

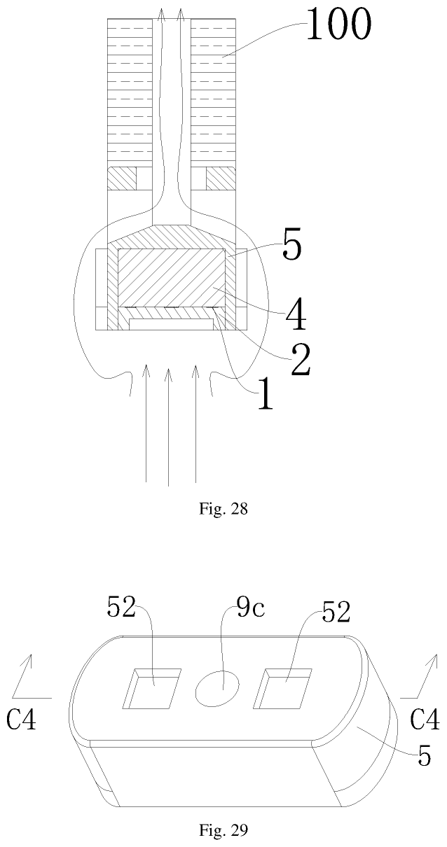

Referring to FIGS. 23 to 28, in some embodiments, the bottom of the cover 5 is matched with the liquid conducting member 4, the top of the cover 5 is provided with a first air port 53a, and the lateral side of the cover 5 is provided with a second air port 53b communicated with the first air port 53a, for airflow to pass through. The number of the first air port 53a and the second air port 53b is unlimited. In this embodiment, two second air ports 53b are provided and located on two lateral sides of the cover 5. The cover 5 may not be provided with a snap structure, and the cover 5 and the reinforcing frame 2 are connected by bonding, ultrasonic welding, or the like. The cover 5 with this structure is generally applied to the heating assembly with a horizontal placement, a bottom air inlet mode, and a lateral side air outlet, where the flow direction of the airflow is shown by the arrows in FIG. 28.

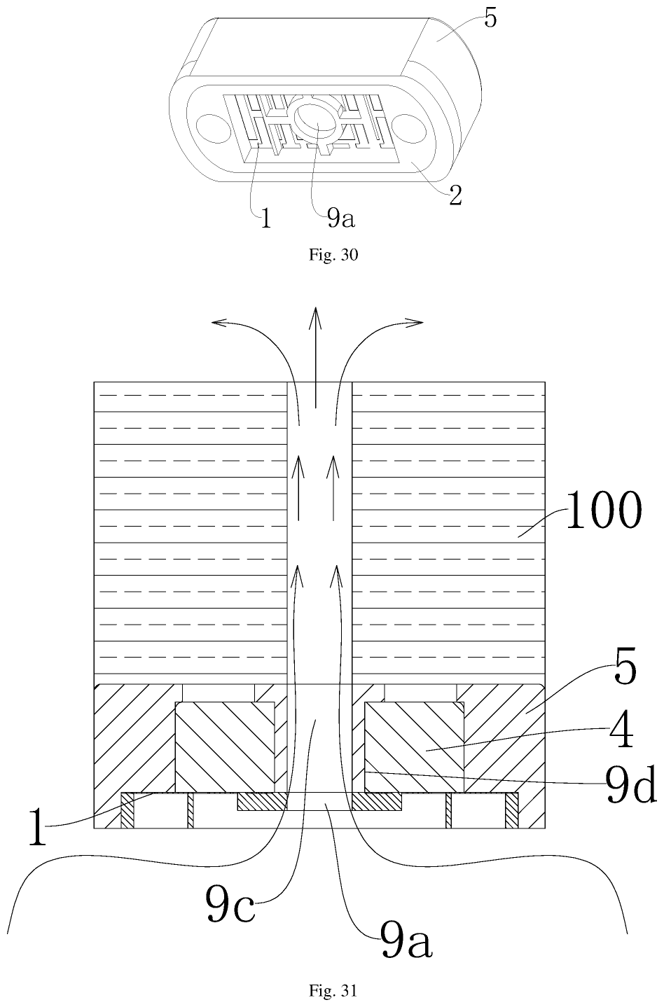

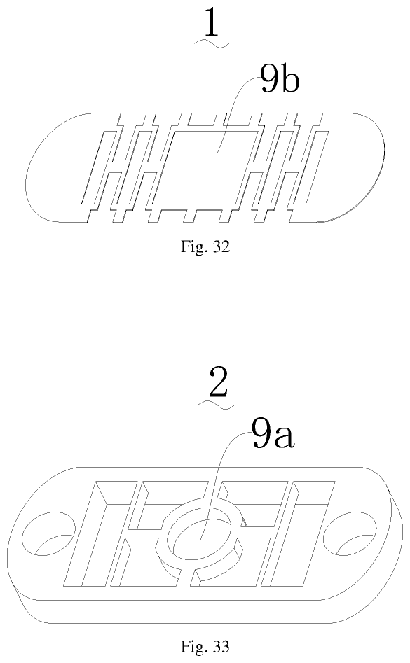

Referring to FIGS. 29 to 33, in other embodiments, the reinforcing frame 2 includes an outer frame portion 21 and an inner frame portion 22. The inner frame portion 22 is disposed in the frame of the outer frame portion 21, the inner frame portion 22 of the reinforcing frame 2 is provided with a first clearance space 9a, the heating portion 11 of the heating sheet 1 is provided with a second clearance space 9b, the cover 5 is provided with a first through hole 9c, and the liquid conducting member 4 is provided with a second through hole 9d. The first through hole 9c passes through the second through hole 9d, and the first clearance space 9a, the second clearance space 9b and the first through hole 9c are aligned and communicated, so that the airflow can pass through the heating assembly, the liquid conducting member 4 and the cover 5. The cover 5 may not be provided with a snap structure, and the cover 5 and the reinforcing frame 2 are connected by bonding, ultrasonic welding, or the like. The cover 5 with this structure is generally applied to the heating assembly with a horizontal placement, a bottom air inlet mode, and a lateral side air outlet, where the flow direction of the airflow is shown by the arrows in FIG. 31.

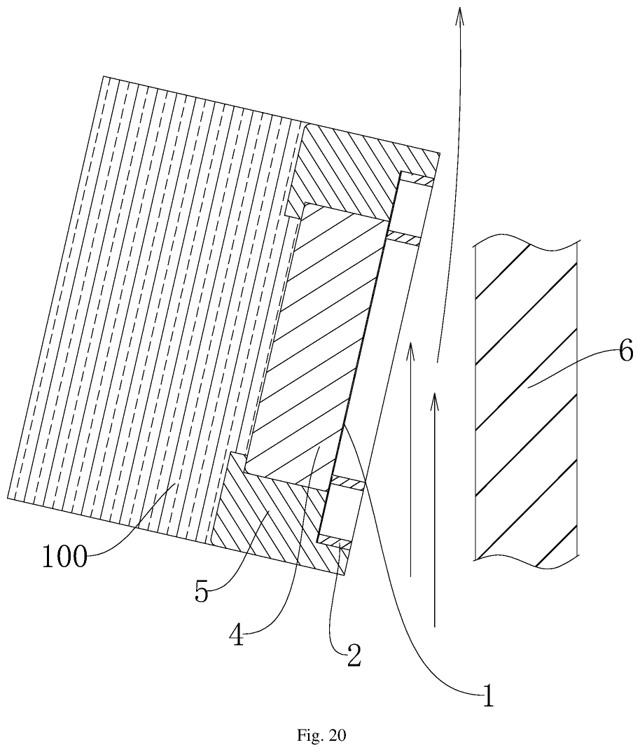

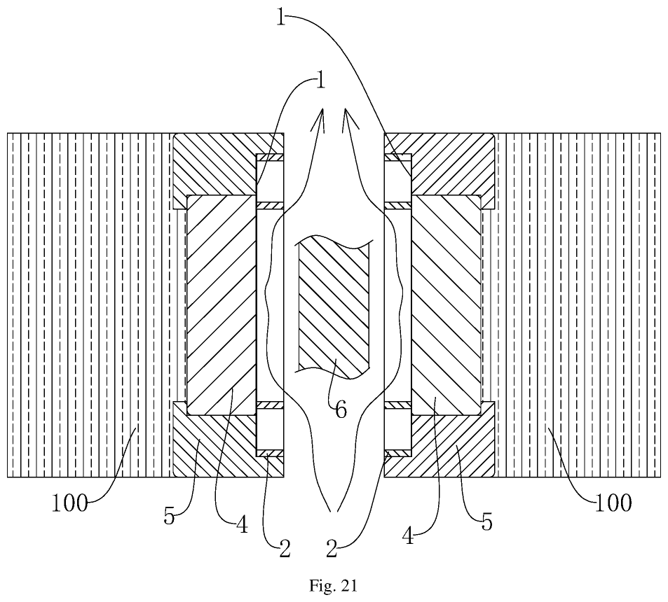

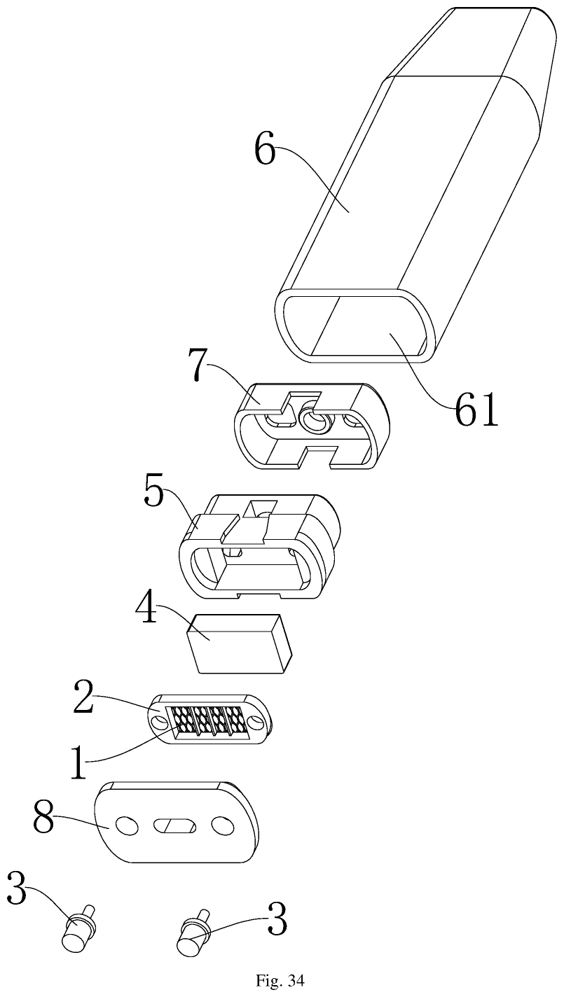

Referring to FIGS. 34 to 37, an atomizer in some embodiments of the present invention includes a housing 6, and the above-mentioned heating assembly or heating unit. The heating assembly is disposed in housing 6, and the side of the heating assembly where the heating sheet 1 is located faces the inner wall of the housing 6. The heating assembly is spaced from the inner wall of the housing 6 and parallel or inclined to the inner wall of the housing 6, so that the airflow passes between the heating sheet 1 and the inner wall of the housing 6. Referring to FIG. 19, the heating assembly is parallel to the inner wall of the housing 6, so that the steam atomized and heated by the heating assembly may be carried out by the air entering from below. Referring to FIG. 20, the heating assembly is inclined to the inner wall of the housing 6, the advantage is that the steam heated and atomized by the heating assembly can be better exposed in the airflow channel and brought out more smoothly.

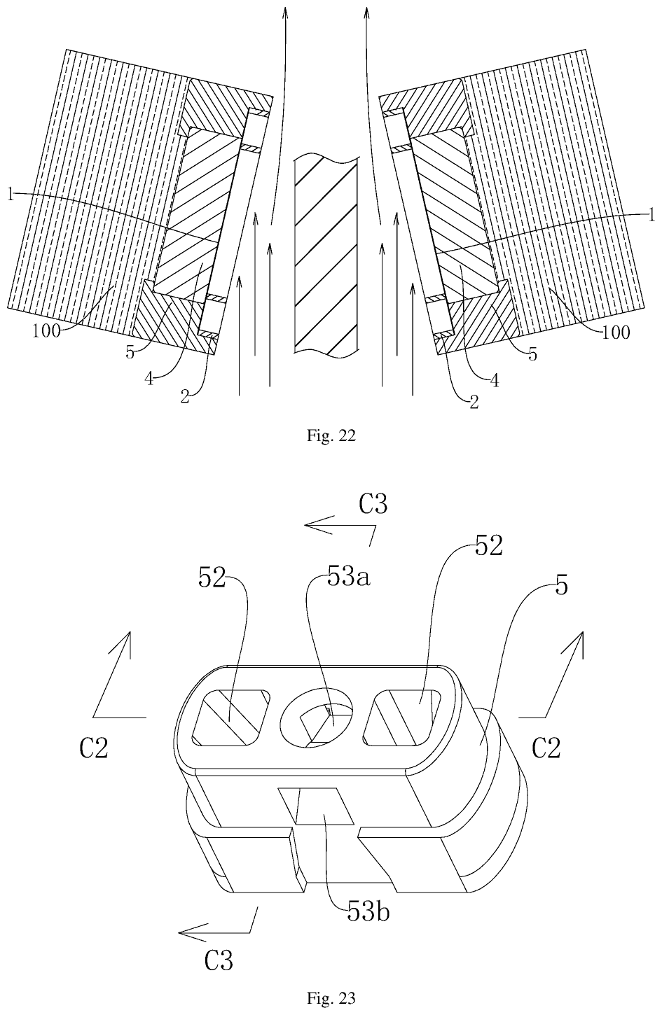

The atomizer may include two heating assemblies arranged on two sides of partial of the inner wall of the housing 6, so that the airflow passes between the heating sheet 1 and the inner wall of the housing 6. Referring FIG. 21, the heating assembly is parallel to the inner wall of the housing 6. Referring to FIG. 22, the heating assembly is inclined to the inner wall of housing 6.

The atomizer specifically includes:

a housing 6, which is provided with a liquid storage cavity 61 for storing liquid;

a liquid storage cavity sealing member 7, configured to seal the liquid of the liquid storage cavity 61 to prevent liquid leakage;

a cover 5, configured to fix the liquid conducting member 4, serving as a support framework of the liquid sealing member, and forming an air flow channel;

a liquid conducting member 4, configured to conduct the liquid 4, to conduct the liquid in the liquid storage cavity 61 to the heating sheet 1;

a heating sheet 1, configured to heat and atomize the liquid conducted by the liquid conducting member 4 to the heating sheet 1; and

a base 8, configured for the fixation of the electrode 3, forming an air flow channel, and serving as the base 8 of the housing 6 of the atomization device.

When the atomization device works, the liquid flows from the liquid storage cavity 61 through a liquid inlet reserved in the liquid storage cavity sealing member 7, through a liquid inlet in the cover 5, and reaches the liquid conducting member 4. The liquid conducting member 4 conducts the liquid to the surface of the heating sheet 1. When the atomization device is powered on, the current flows through the heating sheet 1 through the electrode 3, and the heating sheet 1 generates heat to heat the liquid into atomized steam. When the user inhales at the air outlet of the liquid storage cavity 61, the air enters from the air inlet of the base 8, passes by the heating sheet 1, and brings the atomized steam into the mouth of the human body from the airflow channel of the cover 5 through the airflow channel of the liquid storage cavity 61.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

What is claimed is:

1. A heating assembly, characterized by comprising:
a heating sheet (1), comprising a heating portion (11) and a connecting portion (12) that is connected to the heating portion (11) and configured for electrical connection with an external circuit; and
a reinforcing frame (2);
wherein the heating sheet (1) and the reinforcing frame (2) are arranged side by side to improve the strength of the heating sheet (1);
wherein the heating sheet (1) is embedded on a surface of the reinforcing frame (2) or entirely embedded in the reinforcing frame (2); and
wherein the reinforcing frame (2) is at least combined with all or part of the edge of the heating portion (11) of the heating sheet (1).

2. (canceled)

3. (canceled)

4. (canceled)

5. (canceled)

6. The heating assembly of claim 1, wherein the heating assembly comprises an electrode (3), and the electrode (3) is electrically connected with the connecting portion (12) of the heating sheet (1) to energize the heating sheet (1) through the electrode (3).

7. The heating assembly of claim 6, wherein the electrode (3) is a contact electrode (31), and is electrically connected to the heating sheet (1) by contacting the connecting portion (12) of the heating sheet (1).

8. The heating assembly of claim 6, wherein the electrode (3) is an electrode lead (32), which is connected to the connecting portion (12) of the heating sheet (1) and led out from a surface of the connecting portion (12).

9. The heating assembly of claim 8, wherein the electrode lead (32) extends through the connecting portion (12) of the heating sheet (1) to be connected to the connecting portion (12).

10. The heating assembly of claim 1, wherein the reinforcing frame (2) is made of an insulating material.

11. The heating assembly of claim 10, wherein the heat resistance temperature of the reinforcing frame (2) is above 200° C.

12. (canceled)

13. The heating assembly of claim 1, wherein the reinforcing frame (2) comprises an outer frame portion (21) and an inner frame portion (22), wherein the inner frame portion (22) is arranged in a frame of the outer frame portion (21), and the outer frame portion (21) is combined with the edge of the heating portion (11) of the heating sheet (1), and the inner frame portion (22) is combined with the middle of the heating sheet (1).

14. The heating assembly of claim 13, wherein the outer frame portion (21) and the inner frame portion (22) are combined to form a hollow structure (2a), and the inner frame portion (22) comprises a transverse frame disposed transversely and/or a longitudinal frame disposed longitudinally.

15. A heating unit, characterized by comprising:
a heating assembly;
a liquid conducting member (4) configured for conducting liquid to the heating assembly; and
a cover (5);
wherein the cover (5), the liquid conducting member (4) and the heating assembly are combined, and the liquid conducting member (4) is disposed between the cover (5) and the heating assembly;
wherein the heating assembly comprises:
a heating sheet (1), comprising a heating portion (11) and a connecting portion (12) that is connected to the heating portion (11) and configured for electrical connection with an external circuit; and
a reinforcing frame (2);
wherein the heating sheet (1) and the reinforcing frame (2) are arranged side by side to improve the strength of the heating sheet (1);
wherein the heating sheet (1) is embedded on a surface of the reinforcing frame (2) or entirely embedded in the reinforcing frame (2); and
wherein the reinforcing frame (2) is at least combined with all or part of the edge of the heating portion (11) of the heating sheet (1).

16. The heating unit of claim 15, wherein the cover (5) is provided with a liquid inlet hole (52) communicated with the liquid conducting member (4) for liquid to enter the liquid conducting member (4).

17. The heating unit of claim 15, wherein the bottom of the cover (5) is connected with the liquid conducting member (4), the top of the cover (5) is provided with a first air port (53a), and a lateral side of the cover (5) is provided with a second air port (53b) communicated with the first air port (53a), for airflow to pass therethrough.

18. The heating unit of claim 16, wherein the reinforcing frame (2) comprises an outer frame portion (21) and an inner frame portion (22),
wherein the inner frame portion (22) is arranged in a frame of the outer frame portion (21),
wherein the inner frame portion (22) of the reinforcing frame (2) is provided with a first clearance space (9a), the heating portion (11) of the heating sheet (1) is provided with a second clearance space (9b), and the cover (5) is provided with a first through hole (9c), and
wherein the first clearance space (9a), the second clearance space (9b) and the first through hole (9c) are communicated to allow airflow to pass therethrough.

19. An atomization system, characterized by comprising:
a housing (6); and
at least one heating assembly;
wherein the at least one heating assembly comprises:
a heating sheet (1), comprising a heating portion (11) and a connecting portion (12) that is connected to the heating portion (11) and configured for electrical connection with an external circuit; and
a reinforcing frame (2);
wherein the heating sheet (1) and the reinforcing frame (2) are arranged side by side to improve the strength of the heating sheet (1);
wherein the heating sheet (1) is embedded on a surface of the reinforcing frame (2) or entirely embedded in the reinforcing frame (2); and
wherein the reinforcing frame (2) is at least combined with all or part of the edge of the heating portion (11) of the heating sheet (1);
wherein the at least one heating assembly is disposed in the housing (6), and the side of the at least one heating assembly where the heating sheet (1) is located faces an inner wall of the housing (6), and
wherein the at least one heating assembly is spaced apart from the inner wall of the housing (6) and parallel or inclined with respect to the inner wall of the housing (6), to allow airflow to pass between the heating sheet (1) and the inner wall of the housing (6).

20. The atomization system of claim 19, wherein the at least one heating assembly comprises two heating assemblies arranged on two sides of the inner wall of the housing (6), to allow airflow to pass between the heating sheet (1) and the inner wall of the housing (6).

21. The heating assembly of claim 1, wherein the edge of the reinforcing frame (2) is a flat plane, and the reinforcing frame (2) is combined with all of the edge of the heating portion (11) of the heating sheet (1).

22. The heating assembly of claim 1, wherein the edge of the reinforcing frame (2) is not a flat plane, and the reinforcing frame (2) is combined with part of the edge of the heating portion (11) of the heating sheet (1).

23. The heating assembly of claim 1, wherein the heating portion (11) is curved or reticulated.

24. The heating unit of claim 15, wherein the reinforcing frame (2) comprises an outer frame portion (21) and an inner frame portion (22), wherein the inner frame portion (22) is arranged in a frame of the outer frame portion (21), and the outer frame portion (21) is combined with the edge of the heating portion (11) of the heating sheet (1), and the inner frame portion (22) is combined with the middle of the heating sheet (1).

25. The atomization system of claim 19, wherein the reinforcing frame (2) comprises an outer frame portion (21) and an inner frame portion (22), wherein the inner frame portion (22) is arranged in a frame of the outer frame portion (21), and the outer frame portion (21) is combined with the edge of the heating portion (11) of the heating sheet (1), and the inner frame portion (22) is combined with the middle of the heating sheet (1).
